(19) United States
(12) Patent Application Publication
(10) Pub. No.: US 2008/0246000 A1
(43) Pub. Date: Oct. 9, 2008

(54) Bleaching Composition

(75) Inventors: Hidenari Sakaguchi, Kanagawa (JP); Maya Shimura, Kanagawa (JP)

Correspondence Address: GREENBLUM & BERNSTEIN, P.L.C., 1950 ROLAND CLARKE PLACE, RESTON, VA, 20191, US

(73) Assignee: SHOWA YAKUHIN KAKO CO., LTD., Tokyo (JP)

(21) Appl. No.: 11/575,035

(22) PCT Filed: Sep. 13, 2005
(86) PCT No.: PCT/JP2005/016798

§ 371 Date: Mar. 5, 2008

(30) Foreign Application Priority Data
Sep. 13, 2004 (JP) 2004-265314

(51) Int. Cl. C11D 3/395

(52) U.S. Cl. 252/186.1

(57) ABSTRACT

An object of the present invention is to provide a bleaching composition capable of performing a safe and convenient bleaching without using any peroxidant. The present invention provides a bleaching composition which substantially comprises a visible light-type titanium oxide and water.

### TECHNICAL FIELD

The present invention relates to a bleaching agent that uses neither irritant hydrogen peroxide nor irritant urea peroxide, but attains effects by being irradiated with light.

### BACKGROUND ART

There has been intense demand, in dental therapy, for aesthetic improvement of teeth, and accordingly tooth bleaching has been conducted. Teeth are discolored or stained by the deposition of colored matters contained in favorites such as tobacco or coffee or by proliferation of pigment-producing bacteria. Examples of tooth discoloration include extrinsic discoloration due to the effect of the metal materials and others in the oral cavity, and further include intrinsic tooth discoloration such as discoloration due to aging, discoloration due to metabolic disorder, hereditary tooth discoloration, and discoloration due to tooth disorder. Such extrinsic and intrinsic discolorations are subjected to bleaching treatment.

As the tooth bleaching method, there have been used methods in which a peroxidant such as hydrogen peroxide or urea peroxide, a reductive agent, an acid or an alkali is used. For the purpose of promoting the bleaching effects of these agents, heating and light irradiation are concomitantly applied as the case may be. There has also been known a method in which titanium oxide is prescribed to be combined with a small amount of hydrogen peroxide to attain oxidation ability. However, peroxidants such as hydrogen peroxide and urea peroxide are intensely irritant to skin, and accordingly cautious handling thereof is required so as to be cumbersome.

Further, Japanese Patent Laid-Open No. 2004-83489 describes a tooth bleaching method which is characterized in that a solution containing a titanium oxynitride powder is made to attach on the surface of a tooth, and the tooth is bleached on the basis of the photocatalytic action caused by irradiation of the portion concerned with light such as visible light. However, the titanium oxynitride used in Japanese Patent Laid-Open No. 2004-83489 is cumbersome in the preparation thereof in such a way that it is formed by heat-treating hydrated titanium oxide in an ammonia-containing atmosphere, a nitrogen gas-containing atmosphere or a mixed atmosphere of nitrogen gas and hydrogen gas, or by mixing a titanium oxide powder with urea under stirring and thereafter heating a mixture thus obtained.

### DISCLOSURE OF THE INVENTION

### Means for Solving the Object

The present invention takes, as its problem to be solved, the solution of the above-mentioned prior-art problems. More specifically, the present invention takes, as its problem to be solved, the provision of a bleaching composition capable of performing a safe and convenient bleaching without using any peroxidant. Further, the present invention takes, as its problem to be solved, the provision of a bleaching composition attaining a high bleaching effect with visible light and capable of controlling the bleaching effect through control of visible light.

The present inventors have made a diligent study for the purpose of solving the above-mentioned problems, and have discovered that a bleaching composition which comprises a visible light-type titanium oxide and water, and if desired further comprises a matrix material and a surfactant, can exhibit a bleaching activity with the aid of visible light. Thus, the present invention has been completed.

Thus, the present invention provides the followings.
(1) A bleaching composition which substantially comprises a visible light-type titanium oxide and water.
(2) The bleaching composition according to (1), wherein in the visible light-type titanium oxide, the absorption at 420 nm is 10% or more of the absorption at 350 nm.
(3) The bleaching composition according to (1) or (2), wherein in the visible light-type titanium oxide, the absorption at 420 nm is 20% or more of the absorption at 350 nm.
(4) The bleaching composition according to any one of (1) to (3), wherein the visible light-type titanium oxide is a visible light-type titanium oxide exhibiting a luminescence count of 300/0.1 second or more, the luminescence count being obtained from the luminescence count due to the addition of luminol to the visible light-type titanium oxide immediately after the irradiation of the visible light-type titanium oxide with a blue LED by subtracting therefrom the luminescence count due to the addition of luminol to a purified water sample after the irradiation of the purified water sample with the blue LED.
(5) The bleaching composition according to any one of (1) to (4), which comprises the visible light-type titanium oxide in an amount of 1 to 80% by weight.
(6) The bleaching composition according to any one of (1) to (5), which further comprises a fatty acid compound or a fatty acid ester compound.
(7) The bleaching composition according to (6), wherein the fatty acid compound or the fatty acid ester compound is a nonionic surfactant.
(8) The bleaching composition according to any one of (1) to (7), which further comprises a matrix material.
(9) The bleaching composition according to (8), wherein the matrix material is one or more of light anhydrous silicic acid, vinyl polymers, hydroxypropyl cellulose, agar, gelated hydrocarbons, celluloses, silica compounds, vaseline, waxes and acrylate monomers.
(10) The bleaching composition according to any one of (1) to (9), which further comprises a buffer solution.
(11) The bleaching composition according to (10), wherein the buffer solution is one or more of a phosphate buffer solution, a borate buffer solution, a Tris buffer solution and a Good's buffer solution.
(12) The bleaching composition according to any one of (1) to (11), which further comprises one or more of apatites, calcium phosphates, a fluorine compound, ammonium dodecylsulfate, an ion exchange resin, cellulose, a dye, gold or platinum.
(13) The bleaching composition according to any one of (1) to (12) which is used for tooth bleaching.
(14) The bleaching composition according to any one of (1) to (12) which is used as a tooth brushing agent.
(15) The bleaching composition according to any one of (1) to (12) which is used as a denture cleanser, a clothes cleaning agent or a wall/tile bleaching agent.

### BEST MODE FOR CARRYING OUT THE INVENTION

Hereinafter, an embodiment of the present invention will be described in detail.

A bleaching composition of the present invention is characterized in that it substantially comprises a visible light-type titanium oxide and water, and can be preferably used for tooth bleaching.

The phrase “substantially comprises a visible light-type titanium oxide and water” as referred to in the present description means that the bleaching composition is composed exclusively of a visible light-type titanium oxide and water, or contains optional ingredients which are described below in the present description, but does not contain any other ingredients (for example, peroxides such as hydrogen peroxide, and bioluminescence or chemiluminescence agent).

A visible light-type titanium oxide means a titanium oxide which exhibits an activity in response to the visible light falling approximately within a range from 400 to 900 nm, preferably has the absorption at 420 nm being 10% or more of the absorption at 350 nm, and particularly preferably the absorption at 420 nm being 20% or more of the absorption at 350 nm.

The visible light-type titanium oxides which can be used in the present invention are well known in the art as described, for example, in Japanese Patent Laid-Open No. 2003-12432. The visible light-type (visible light-responsive) titanium oxide which can be used in the present invention is, for example, a photocatalyst which is activated with the action of light of 420 nm or more in wavelength, and more preferably with the action of light of 450 nm or more in wavelength.

The visible light-responsive titanium oxide which is used in the present invention may be, for example, a visible light-type photocatalyst composed of titanium dioxide having stable oxygen defects described in International Publication No. WO00/10706 or WO02/068576, or may be various visible light-responsive materials which are described below. The ESR spectrum of the visible light-type photocatalyst described in International Publication No. WO00/10706 or WO02/068576 has only a signal having a g-value of 2.003 to 2.004 in an ESR measurement carried out under vacuum at 77K in the dark.

Representative examples of the visible light-responsive titanium oxide may include: a titanium oxide mainly composed of an anatase-type titanium oxide, and a titanium oxide containing an amorphous titanium oxide in addition to the anatase-type titanium oxide; and a titanium oxide mainly composed of a rutile-type titanium oxide, and a titanium oxide containing an amorphous titanium oxide in addition to the rutile-type titanium oxide. The above-mentioned titanium oxide constituting a visible light-responsive material composed of a titanium oxide mainly composed of an anatase-type titanium oxide can be non-stoichiometric with respect to titanium and oxygen; specifically, the amount of oxygen relative to the amount of titanium may be smaller than the stoichiometric ratio (theoretical ratio: 2.00) in titanium dioxide. The titanium oxide in the above-mentioned visible light-responsive material has a molar ratio of oxygen to titanium to be less than 2.00, for example, 1.00 to 1.99 or 1.50 to 1.95. The molar ratio of oxygen to titanium in the titanium oxide in the above-mentioned visible light-responsive material can be measured, for example, with X-ray photoelectron spectroscopy. In the present invention, a visible light-responsive titanium oxide that does not contain nitrogen is used.

The visible light-responsive titanium oxide as mentioned above can be prepared with an amorphous or imperfect crystalline titanium oxide (containing hydrated titanium oxide) and/or titanium hydroxide as raw materials, for example, according to the method described in Japanese Patent Laid-Open No. 2003-12432.

Preferably in the present invention, a visible light-type titanium oxide which exhibits a luminescence count of 300/0.1 second or more can be used, the luminescence count being obtained from the luminescence count due to the addition of luminol to the visible light-type titanium oxide immediately after the irradiation of the visible light-type titanium oxide with a blue LED by subtracting therefrom the luminescence count due to the addition of luminol to a purified water sample after the irradiation of the purified water sample with the blue LED.

The content of the visible light-type titanium oxide in the bleaching composition of present invention is not particularly limited, but is generally approximately 1 to 80% by weight, preferably approximately 5 to 70% by weight, and more preferably approximately 10 to 70% by weight. When the bleaching composition of the present invention is composed exclusively of the visible light-type titanium oxide and water, the content of the visible light-type titanium oxide is preferably approximately 20 to 70% by weight and preferably approximately 40 to 55% by weight.

The bleaching composition of the present invention may also contain, if desired, a fatty acid compound or a fatty acid ester compound. Examples of the fatty acid compound and the fatty acid ester compound, which can be used in the present invention, may include the following.

### (1) Nonionic Surfactants

Sorbitan fatty acid esters, polyoxyethylenesorbitan monooleate, glycerin monostearate, glycerin monooleate, glycerin fatty acid esters, diethanolamide laurate, Nonion (NOF Corp.), Monogly (NOF Corp.), and Stafoam (NOF Corp.).

### (2) Anionic Surfactants

Sodium laurylsulfate, triethanolamine laurylsulfate, stearoylmethyl taurime sodium, palm oil fatty acid sarcosine sodium Persoft (NOF Corp.), Diapon (NOF Corp.), Sunamide (NOF Corp.) and Filet (NOF Corp.).

### (3) Cationic Surfactants

Benzalkonium chloride, lauryltrimethylammonium chloride, cetyltrimethylammonium chloride, stearyltrimethylammonium chloride, and Cation (NOF Corp.).

### (4) Amphoteric Surfactant Nissanamino (NOF Corp.).

(5) Polymer activators

Solution of sodium salt of maleic anhydride-diisobutylene copolymer.

(6) Fatty acids

Oleic acid, caproic acid, caprylic acid, capric acid, lauric acid, myristic acid, palmitic acid and stearic acid.

### (7) Others

Fatty acid alcohols, aliphatic amines, glycerin, metal soaps, and oil fatty acid esters.

The content of a fatty acid compound or a fatty acid ester compound in the bleaching composition of the present invention is not particularly limited, but is generally approximately 0 to 50% by weight, preferably approximately 0 to 40% by weight and particularly preferably approximately 10 to 30% by weight.

The bleaching composition of the present invention may further contain a matrix material. Examples of the matrix material which can be used in the present invention may include light anhydrous silicic acid, vinyl polymers (such as carboxyvinyl polymer), hydroxypropyl cellulose, agar, gelated hydrocarbons, celluloses, silica compounds, vaseline, waxes and acrylate monomers. These may be used each alone or in combinations of two or more thereof.

The content of the matrix material in the bleaching composition of the present invention is not particularly limited, but is generally approximately 0 to 70% by weight, and preferably approximately 0 to 60% by weight.

The bleaching composition of the present invention may further contain a buffer solution. Examples of the buffer solutions which can be used in the present invention may include a phosphate buffer solution, a borate buffer solution, a Tris buffer solution and a Good's buffer solution. These may be used each alone or in combinations of two or more thereof. The pH of the buffer solution is preferably 4 to 10. The buffer solution may contain sodium carbonate.

The content of the buffer solution in the bleaching composition of the present invention is not particularly limited, but is generally approximately 0 to 90% by weight.

The bleaching composition of the present invention may further contain, if desired, one or more of apatites, calcium phosphates, a fluorine compound, ammonium dodecylsulfate, an ion exchange resin, cellulose, a dye, gold or platinum.

Apatites (such as hydroxyapatite), calcium phosphates and fluorine compounds are the ingredients widely used for the purpose of strengthening and protecting teeth in the dental field, and the addition of these ingredients can prevent tooth caries. Examples of the usable ion exchange resins may include anion exchange resins (such as a resin containing a quaternary ammonium as a functional group thereof), cation exchange resins (such a resin containing SO₃⁻ as a functional group thereof), and resins for concentration of organic matters. Examples of the dyes may include rhodamine B, Food Blue No. 1, Food Blue No. 4, Food Yellow No. 5 and a green tea powder.

The content of each of the above-mentioned optional ingredients in the bleaching composition of the present invention is not particularly limited, but is generally approximately 0 to 20% by weight and more preferably approximately 0 to 10% by weight.

The above-mentioned bleaching composition of the present invention can take such forms as a solid, a solution and a gel. The bleaching composition of the present invention may further contain, in addition to the above-mentioned ingredients, a solvent, a fragrance, xylitol, quinones, stabilizers and others. The bleaching composition of the present invention is particularly used for tooth bleaching, but also can be used for bleaching other articles; specifically, the bleaching composition of the present invention can be used as a tooth brushing agent, a denture cleanser, a clothes cleaning agent, or a wall/tile bleaching agent. The bleaching composition composed exclusively of the visible light-type titanium oxide and water is particularly preferably used for tooth bleaching.

The present invention will be described more specifically with reference to the following examples, but the present invention is not limited by the examples.

### EXAMPLES

The visible light-type titania used in the following examples is a visible light-responsive photocatalytic titanium (purchased from Ecodevice Co., Ltd., with the absorption curve shown in FIG. 1). This visible light-responsive photocatalytic titanium exhibited a luminescence count of 300/0.1 second or more, the luminescence count being obtained from the luminescence count due to the addition of luminol to the visible light-type titanium oxide immediately after the irradiation of the visible light-type titanium oxide with a blue LED by subtracting therefrom the luminescence count due to the addition of luminol to a purified water sample after the irradiation of the purified water sample with the blue LED.

### Test Example 1

### (1) Samples

Sample concentration: 0.4 mg/mL; titania samples (a visible light-type titania (TiO), anatase-type titania (ANA), rutile-type titania (RTL), amorphous-type titania (AMO)) (the anatase-type titania, rutile-type titania and amorphous-type titania were purchased from Wako Pure Chemicals, Ltd.),

purified water

### (2) Experimental Method

The luminescence count before reaction was defined as the luminescence count obtained for 2 seconds from 50-μEL of a sample irradiated with a 250 LUX blue EL for 30 seconds. After the measurement of the luminescence count before reaction, the sample was again irradiated for 30 seconds with the blue EL, and immediately after the completion of the irradiation, the same amount of a 5-mM aqueous luminol solution (pH 9.5) was added to the sample; then, the luminescence count for 2 seconds was measured for 2 seconds with a unit of 0.1 second by using a Luminescensor PSN [AB-2200, ATTO Corp.]. A luminescence count was derived, as the radical luminescence count, from the value measured for the sample by subtracting therefrom the luminescence count before reaction and the values measured for the purified water.

### (3) Results

Immediately after the addition of luminol, the luminescence reaction started, and thus, the radical generation from the visible light-type titania (TiO) was able to be identified (FIG. 8). On the other hand, although the anatase-lype titania, the rutile-type titania and the amorphous-type titania each exhibited a luminescence reaction to a certain extent, the luminescence counts thereof were 250 or less (FIG. 8).

### Example 1

### Bleaching Power of the Visible Light-Type Titanium for Hematoporphyrin as a Function of Illuminance

### (1) Samples

A visible light titania sample was prepared by kneading 50% by weight of a visible light-type titania and 50% by weight of distilled water with each other. As a reference, a blank was prepared by kneading 50% by weight of a titana (anatase type)(manufactured by Wako Pure Chemicals, Ltd.) and 50% by weight of distilled water with each other.

### (2) Experimental Method

Filter paper specimens of 6 mm in diameter were soaked in a 0.1% solution of hematoporphyrin, allowed to stand 1 day, and then dried to prepare dyed filter paper specimens. Each of the dyed filter paper specimens was subjected to the measurement of the surface thereof with a color-difference spectrometer (Nippon Denshoku Co., Ltd.), to obtain initial values (a*1, b*1, L*1). Under a red lamp of 10 LUX in illuminance, the surface of each of the 10 dyed filter paper specimens was coated with the sample or the blank so as for the coating thickness to be approximately 0.5 mm, and was covered with a cover glass. By using a white light lamp having light wavelengths only in the visible light range (400 to 750 nm) and a visible light irradiation device (LT-120, Nagano Science Co., Ltd.), irradiation of light to the coated surfaces of the dyed filter paper specimens was made for 15 minutes with a low illuminance of 1000 LUX, a medium illuminance of 2000 LUX and a high illuminance of 3000 LUX, to examine the bleaching effect (20° C.). Immediately after irradiation, the dyed filter paper specimens were washed for 15 minutes in 500 mL of purified water, and were again washed. After washing, the dyed filter paper specimens were dried at 40° C. for 1 hour, and then the surface of each of the dyed filter paper specimens was subjected to the measurement with the color-difference spectrometer (Nippon Denshoku Co., Ltd.), to obtain measured values (a*2, b*2, L*2). By subtracting the initial values from the measured values, there were obtained values Δa*, Δb*, and ΔL*; these values were squared and summed; then, the square root of the sum was obtained to be defined as ΔE.

### (3) Results

The dyed filter paper specimens coated with the blank exhibited a ΔE value of 2 or less, and no color change was observed with the naked eye (FIG. 2). Each of the dyed filter paper specimens coated with the sample was high in the ΔE value even before irradiation, and was increased in the ΔE value and became white with the increase of the illuminance (FIG. 3).

### Example 2

### Bleaching Power of the Visible Light-Type Titania for Hematoporphyrin as a Function of Irradiation Time

### (1) Sample

A visible light titania sample was prepared by kneading 40% by weight of a visible light-type titania and 60% by weight of distilled water.

### (2) Experimental Method

Filter paper specimens of 6 mm in diameter were soaked in a 0.1% solution of hematoporphyrin to be dyed. The dyed filter paper specimens were dried at 50° C. for 1 hour, and then washed twice with 40 mL of distilled water to prepare dyed filter paper specimens. Each of the dyed filter paper specimens was subjected to the measurement of the surface thereof with a color-difference spectrometer (Nippon Denshoku Co., Ltd.), to obtain initial values (a*1, b*1, L*1). Under the red lamp of 10 LUX in illuminance, the surface of each of the 10 dyed filter paper specimens was coated with the sample or the blank so as for the coating thickness to be approximately 0.5 mm, and was covered with a cover glass. By using the white light lamp having light wavelengths only in the visible light range (400 to 750 nm) and a visible light irradiation device (LT-120, Nagano Science Co., Ltd.), irradiation of light to the coated surfaces of the dyed filter paper specimens was made with 3000 LUX for 30 minutes, 3 hours, 7 hours and 24 hours, to examine the bleaching effect (20° C.). Immediately after irradiation, the dyed filter paper specimens were washed for 15 minutes in 500 mL of purified water, and were again washed. After washing, the dyed filter paper specimens were dried at 40° C. for 1 hour, and then the surface of each of the dyed filter paper specimens was subjected to the measurement with the color-difference spectrometer (Nippon Densholu Co., Ltd.), to obtain measured values (a*2, b*2, L*2). By subtracting the initial values from the measured values, there were obtained values Δa*, Δb*, and ΔL*; these values were squared and summed; then, the square root of the sum was obtained to be defined as ΔE.

### (3) Results

The ΔE values were increased with the increase of the irradiation time, and the bleaching effect was able to be controlled by the light quantity (FIG. 4).

### Example 3

### Oxidative Decomposition of Discolored Minocycline

### (1) Samples

Each of the samples was prepared by mixing under stirring 10% by weight of a visible light-type titania, 20% by weight of any one of the following fatty acid compounds, 2% by weight of hydroxypropylmethyl cellulose and 68% by weight of a phosphate buffer solution. Each ofthe following fatty acid compounds was examined: lauric acid, myristic acid, palmitic acid and stearic acid.

### (2) Experimental Method

A 2,500-ppm solution of minocycline hydrochloride was irradiated with light for discoloration to prepare a discolored minocycline solution. To 1 g of each of the samples irradiated with a blue LED for 15 minutes, 2 mL of the discolored minocycline solution was added, and the solution thus obtained was stirred and incubated at 37° C. for 15 minutes; thereafter, the solution was subjected to centrifugal separation to obtain the supernatant liquid, which was subjected to measurement with a spectrophotometer. The absorbance of each of the supernatant liquids was derived on the basis of the assumption that the absorbance of the maximum absorption peak of the discolored minocycline was set at 100%.

### (3) Results

The maximum absorption peak of the discolored minocycline was found to have a λmax value of 348 nm, and the addition of each of the samples made the peak at 348 nm smaller and made the color of the discolored minocycline pale and clear (FIG. 5).

### Example 4

### Bleaching of Hematoporphy Filter Paper Specimens

### (1) Samples

Each of the samples was prepared by mixing under stirring 15% by weight of a visible light-type titania, 30% by weight of a fatty acid compound or a fatty acid ester compound, 2% by weight of carboxyvinyl polymer and 53% by weight of a borate buffer solution. As blanks, there were prepared pastes each composed of 23% by weight of a fatty acid compound or a fatty acid ester compound, 3% by weight of light anhydrous silicic acid and 74% by weight of a phosphate buffer solution. Each of the following fatty acid compounds and fatty acid ester compound was examined: a sorbitan fatty acid ester (trade name: Nonion, NOF Corp.), stearic acid and lauric acid.

### (2) Experimental Method

Filter paper specimens of 6 mm in diameter were soaked in a 0.1% solution of hematoporphyrin, allowed to stand 1 day, and then dried to prepare dyed filter paper specimens. Each of the dyed filter paper specimens was subjected to the measurement of the surface thereof with a color-difference spectrometer (Nippon Denshoku Co., Ltd.), to obtain initial values (a*1, b*1, L*1). The surface of each of the 10 dyed filter paper specimens was coated with any one of the samples, and was irradiated with a blue LED for 15 minutes. Thereafter, each of the dyed filter paper specimens was washed in 500 mL of purified water for 15 minutes, and was again washed. After washing, the dyed filter paper specimens were dried at 40° C. for 1 hour, and then the surface of each of the dyed filter paper specimens was subjected to the measurement with the color-difference spectrometer (Nippon Denshoku Co., Ltd.), to obtain measured values (a*2, b*2, L*2). By subtracting the initial values from the measured values, there were obtained values Δa*, Δb*, and ΔL*; these values were squared and summed; then, the square root of the sum was obtained to be defined as ΔE.

### (3) Results

As shown in FIG. 6, although the ΔE value was approximately 1 to 2 with coating of the blank, the coating of the individual samples containing titania obviously increased the ΔE values of the discolored filter paper specimens and whitened the discolored filter paper specimens.

### Example 5

### Bleaching of a Stained Matter

### (1) Sample

A sample was prepared by mixing under stirring 17% by weight of a visible light-type titania, 10% by weight of Nonion, 1% by weight of light ahydrous silicic acid, 2% by weight of tricalcium phosphate and 70% by weight of tap water.

### (2) Experinmental Method

As a ceramic model, calcium phosphate pellets were prepared so as to have a density of 80% or more, Each of the ceramic specimens was added with coffee with sugar and cream, curry, or soy sauce, was allowed to stand for 30 days; thereafter, the ceramic specimens were washed with water and then dried. The surface of each of the dried ceramic specimens was subjected to the measurement with the color-difference spectrometer (Nippon Denshoku Co., Ltd.), to obtain initial values (a*1, b*1, L*1). The surface of each of the ceramic specimens was coated with the sample and irradiated with a blue LED for 15 minutes. Thereafter, each of the ceramic specimens was washed in 500 mL of purified water for 15 minutes, and was again washed. After washing, the ceramic specimens were dried at 40° C. for 1 hour, and then the surface of each of the ceramic specimens was subjected to the measurement with the color-difference spectrometer (Nippon Denshoku Co., Ltd.), to obtain measured values (a*2, b*2, L*2). By subtracting the initial values from the measured values, there were obtained values Δa*, Δb*, and ΔL*; these values were squared and summed; then, the square root of the sum was obtained to be defined as ΔE.

### (3) Results

As shown in FIG. 7, the ceramic specimens were large in the ΔE value, and became white.

### INDUSTRIAL APPLICABILITY

The present invention has made it possible to provide a bleaching composition capable of bleaching safely and conveniently without using any peroxidant.

### BRIEF DESCRIPTION OF THE DRAWINGS

FIG. 1 shows an absorption curve of a visible light-responsive photocatalytic titanium used in the examples.

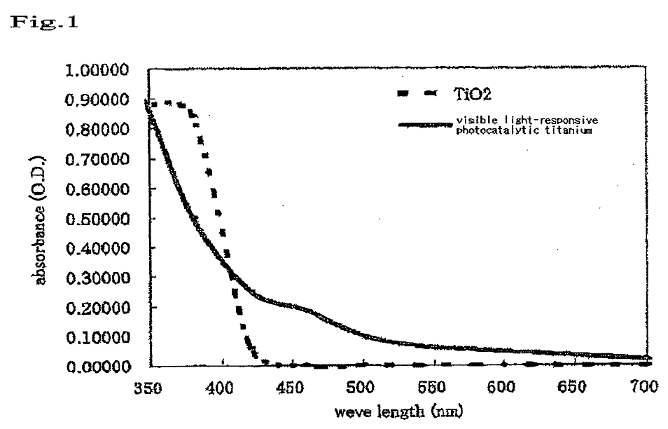

FIG. 2 shows a bleaching of a dyed filter paper specimen effected with a blank (ordinary titania) as a function of illuminance.

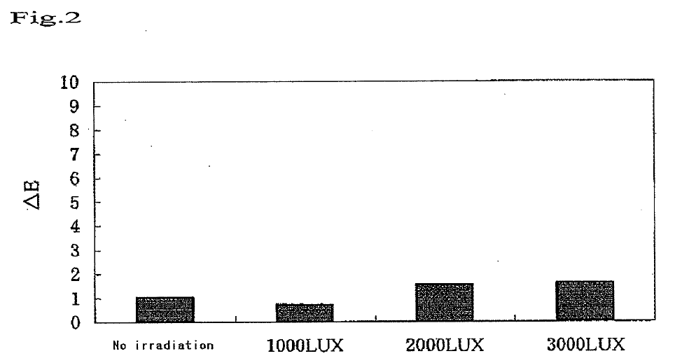

FIG. 3 shows the degree of bleaching of a dyed filter paper specimen effected with a visible light titania as a function of illuminance.

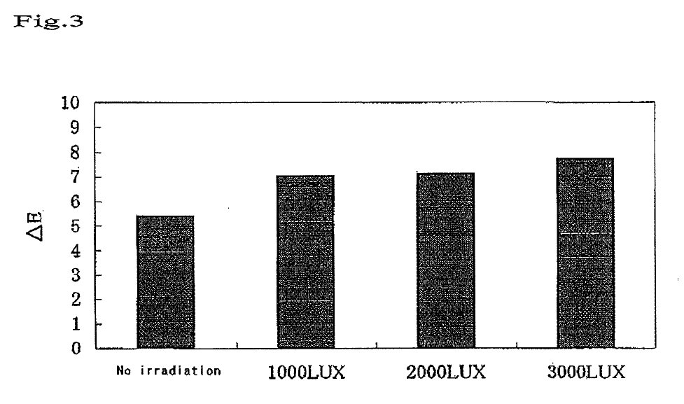

FIG. 4 shows the degree of bleaching of a dyed filter paper specimen effected with a visible light titania as a function of light irradiation time.

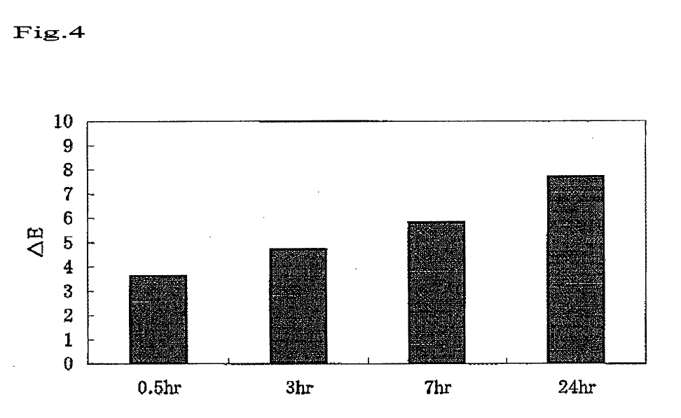

FIG. 5 shows the bleaching and oxidative decomposition of discolored minocycline effected with a fatty acid compound and a titania sample.

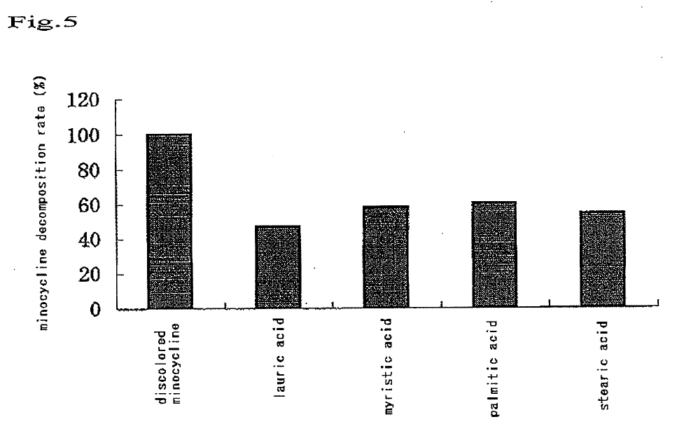

FIG. 6 shows a bleaching of a filter paper specimen effected with a blue LED.

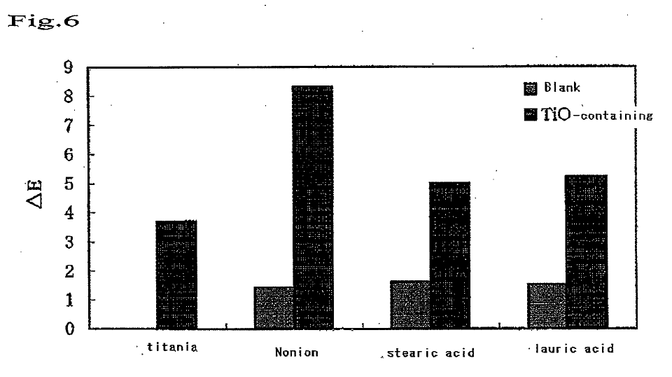

FIG. 7 shows a bleaching of a ceramic specimen effected with a blue LED.

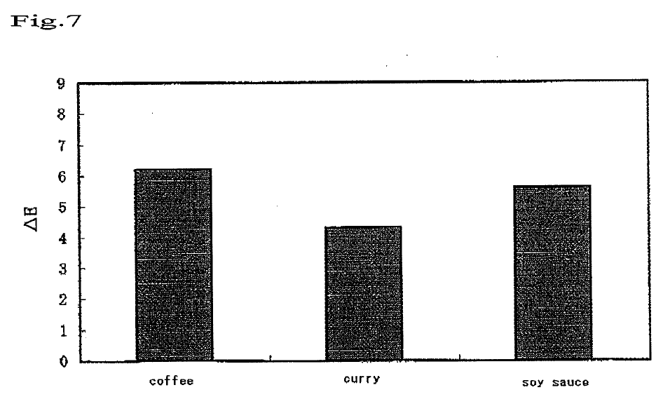

FIG. 8 shows radical-luminol luminescence curves of various titanias.

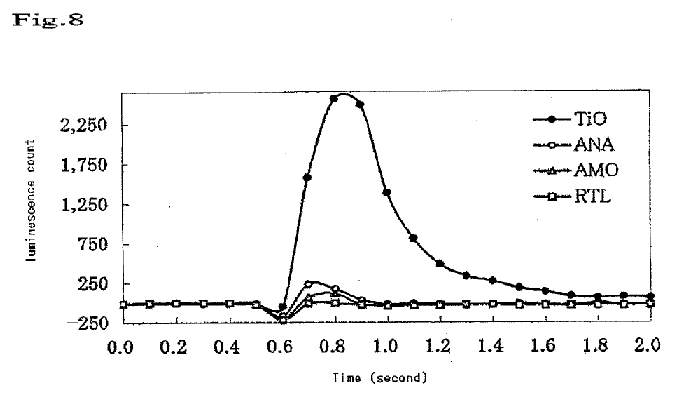

1. A bleaching composition which substantially comprises a visible light-type titanium oxide and water.

2. The bleaching composition according to claim 1, wherein in the visible light-type titanium oxide, the absorption at 420 nm is 10% or more of the absorption at 350 nm.

3. The bleaching composition according to claim 1, wherein in the visible light-type titanium oxide, the absorption at 420 nm is 20% or more of the absorption at 350 nm.

4. The bleaching composition according to claim 1, wherein the visible light-type titanium oxide is a visible light-type titanium oxide exhibiting a luminescence count of 300/0.1 second or more, the luminescence count being obtained from the luminescence count due to the addition of luminol to the visible light-type titanium oxide immediately after the irradiation of the visible light-type titanium oxide with a blue LED by subtracting therefrom the luminescence count due to the addition of luminol to a purified water sample after the irradiation of the purified sample with the blue LED.

5. The bleaching composition according to claim 1, which comprises the visible light-type titanium oxide in an amount of 1 to 80% by weight.

6. The bleaching composition according to claim 1, which further comprises a fatty acid compound or a fatty acid ester compound.

7. The bleaching composition according to claim 6, wherein the fatty acid compound or the fatty acid ester compound is a nonionic surfactant.

8. The bleaching composition according to claim 1, which further comprises a matrix material.

9. The bleaching composition according to claim 8, wherein the matrix material is one or more of light anhydrous silicic acid, vinyl polymers, hydroxypropyl cellulose, agar, gelated hydrocarbons, celluloses, silica compounds, vaseline, waxes and acrylate monomers.

10. The bleaching composition according to claim 1, which further comprises a buffer solution.

11. The bleaching composition according to claim 10, wherein the buffer solution is one or more a phosphate buffer solution, a borate buffer solution, a Tris buffer solution and a Good's buffer solution.

12. The bleaching composition according to claim 1, which further comprises one or more of apatites, calcium phosphates, a fluorine compound, ammonium dodecylsulfate, an ion exchange resin, cellulose, a dye, gold or platinum.

13. The bleaching composition according to claim 1, which is used for tooth bleaching.

14. The bleaching composition according to claim 1, which is used as a tooth brushing agent.

15. The bleaching composition according to claim 1, which is used as a denture cleanser, a clothes cleaning agent or a wall/tile bleaching agent.
